(19) United States
(12) Patent Application Publication
(10) Pub. No.: US 2006/0086021 A1
(43) Pub. Date: Apr. 27, 2006

(54) Display apparatus

(75) Inventor: John Peter Stephenson, Sunningdale (GB)

Correspondence Address: FAEGRE & BENSON LLP;PATENT DOCKETING, 2200 WELLS FARGO CENTER, MINNEAPOLIS, MN, 55402, US

(73) Assignee: Ether-Tec International, Aldershot (GB)

(21) Appl. No.: 11/213,487

(22) Filed: Aug. 26, 2005

(30) Foreign Application Priority Data
Aug. 26, 2004 (EP) 04255174.7

(51) Int. Cl. G09F 13/04

(52) U.S. Cl. 40/564

(57) ABSTRACT

The sign 10 of the present invention has a drop-down cassette 12 that can be worked on single handed at ground level with speed, safety and efficiency where in its elevated position the cassette 12 is housed behind convexly curved Polycarbonate panels 13 which allow display of posters loaded onto the cassette 12. The sign 10 removes the principal problem attached to prior known form of high level advertising, namely, the difficulty of access without costly special equipment to change advertising posters and to maintain and repair all working electrical parts.

### BACKGROUND OF THE INVENTION

This invention relates to display signs for displaying information, and in particular, although not exclusively to illuminated signs.

The most widespread type of illuminated display sign used in the United Kingdom and elsewhere is one that measures 1.8 m by 1.2 m and known in the trade as a “six-sheet panel”. This size of sign has its origins in the fact that this was the maximum size that would easily fit on the end of panels of a standard covered bus stop shelter.

Traditionally, advertising space on bus shelters and other display signs is very big business and illuminated displays have developed into a major sector of the advertising industry. The usual practice is to sell the advertising space for periods of 14 days. Therefore the advertising material carried by the sign may need to be changed at least every two weeks.

The major operators who own these signs would have typically between 10,000 and 65,000 signs at various locations. It follows, that changing the displays on a weekly or two-weekly basis is very labour intensive and extremely expensive.

The advertising industry and organisations needing to disseminate information to the public have increasingly attracted attention to their messages by placing an illuminated image and/or written messages in prominent positions. This is especially effective at night or in low light conditions.

Illuminated displays have developed into a major sector of the advertising industry known as Outdoor Advertising. As a typical example, in the UK it occupies a market share of 10% of the total advertising market including newspapers, magazines, TV and radio.

Virtually all the six-sheet displays are back illuminated and these types of signs can demand much higher rental than non-illuminated signs. In order to justify the payment of significantly higher rentals for illuminated signs, the media buying houses that buy advertising space from the owners of the display signs carry out an inspection of a random selection of signs.

If any signs are not illuminated or otherwise are not working then the media buying houses will take the percentage of non-illuminated signs to be systematic of the whole population of illuminated signs that the media buying house is renting. The media buying houses will then seek a reduction in the total rental to reflect the percentage of non-working illuminated signs. There is therefore, an incentive for the owners of the signs to ensure that all illuminated signs are fully working and maintain fully functional.

Illuminated signs attract vandalism and steps have to be taken to reduce damage by vandals so as to reduce the percentage of non-working signs due to vandalism. Two prior known ways of combating vandalism reside in using reinforced glass panels instead of lightweight transparent plastics panels that can become scratched easily. This is extremely costly.

Additionally, or alternatively, the signs are located at heights that are inaccessible to vandals. Placing signs out of reach of vandals presents its own problems because of the need for expensive hydraulic lifting platforms, scaffolding towers, scaffolding, or ladders when replacing advertising material or repairing or replacing lighting components and for carrying out maintenance. Not only are these solutions very expensive, but the need to comply with Health and Safety legislation to protect the maintenance staff that have to change the display material or effect repair can require two people in attendance to change the advertising materials. This is very expensive.

### BRIEF SUMMARY OF THE INVENTION

An object of the present invention is to provide a display device that reduces the need for any special and costly equipment to change the information displayed.

A further object is to provide a display device that enables a person operation for poster fixing campaigns, weekly cleaning and regular maintenance and repairs of the display device.

A further object of the present invention is to provide speedier access to elevated display devices that is comparable to that of pavement based boxes.

According to one aspect of the present invention there is provided a display apparatus for the display of advertising or other information comprising a rigid frame structure adapted to be clamped to a post in an elevated position, characterised by a drop down cassette the faces of which are designed to accept translucent advertising or public information posters and containing within the cassette electrical working parts of the apparatus and one or more lamps to illuminate the posters.

Optional subsidiary features which may be included in embodiments of the present invention are defined in claims 2 to 14.

The or each lamp may be a fluorescent lamp. The counterbalance means may comprise at least one shock cord.

According to another aspect of the present invention there is provided a drop down cassette for a display apparatus as defined above.

### BRIEF DESCRIPTION OF THE SEVERAL VIEWS OF THE DRAWINGS

The present invention will now be described by way of example in which:

FIG. 1 shows a display sign constructed in accordance with the present invention;

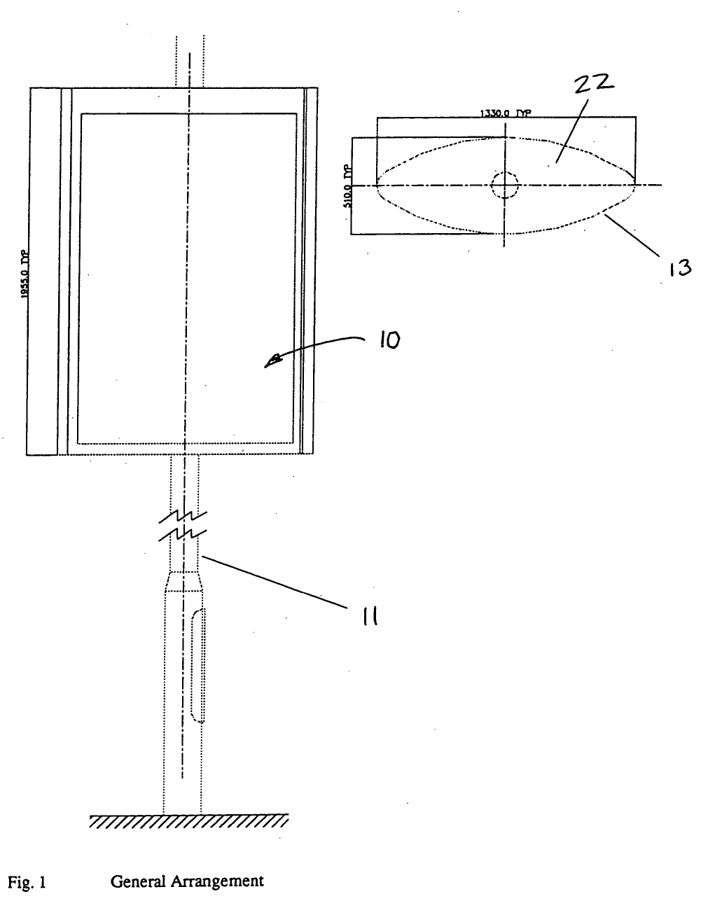

FIG. 2 shows in greater detail the internal structure of the sign of FIG. 1;

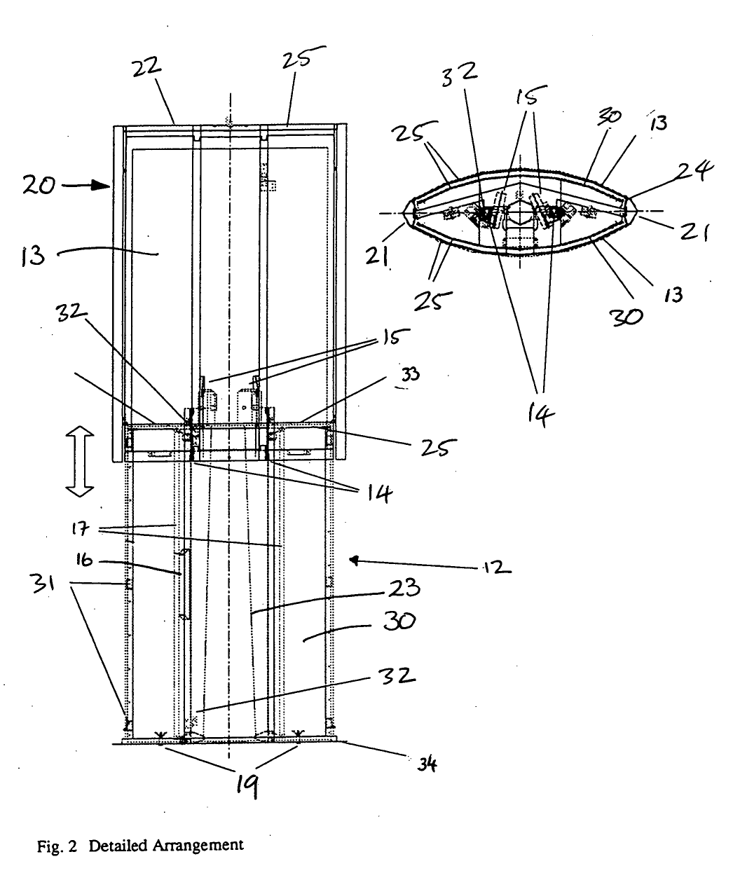

FIG. 3 shows a clamping arrangement of the sign shown in FIGS. 1 and 2.

### DETAILED DESCRIPTION OF THE INVENTION

Referring to the drawings there is shown an illuminated sign 10 that can be placed in an elevated position (typically above 2 metres and preferably 3 metres from the ground) on a street lamp-post 11 or similar post, to attract maximum attention.

The sign 10 of the present invention has a drop-down cassette 12 that can be worked on single handed at ground level with speed, safety and efficiency. When in its elevated position, the cassette 12 is housed behind convexly curved Polycarbonate panels 13 which allow display of posters loaded onto the cassette 12. The sign 10 removes the principal problem attached to prior known forms of high level advertising, namely, the difficulty of access without costly special equipment to change advertising posters and to maintain and repair all working electrical parts.

The cassette 12 comprises typically a double sided back lit six-sheet sign with an aesthetic outwardly convex curved translucent panel 30 on both sides of the cassette 11. The top of the cassette 12 is provided with internal top plates 33 and the bottom of the cassette 12 is provided with a base plate 34 which forms an external surface of the sign 10 when the cassette is in its elevated position. Both the top plates 33 and base plate 34 may be of Aluminium. The translucent diffuser panels 30 are highly reflective and are retained by curved aluminium extrusions 25 to the box base plate 34 and internal top plates 33. The reflective and diffuser characteristics of the panels 30 may be provided by a film applied to a main body of the panels 30.

Posting of advertising materials is achieved by unlocking and lowering the cassette 12 as described below and locating suitable posters on the translucent panels 30. Clips 31 are provided for securing posters to the translucent diffuser panels 30. The drop-down cassette 11 moves up and down on a low friction sliding mechanism 14 with two aluminium extrusions being provided in the cassette 12 as part of the sliding mechanism 14. The entire weight of the cassette 11 is counterbalanced with a counterbalance device in the form of constant tension tool balancers 15 to give minimal effort in lowering and raising the cassette 12.

In alternatives other counter balancing mechanisms may be used such as shock cords in conjunction with a pulley system to provide a more constant opposing force to the cassette 11. The shock cords may be used without a pulley system and may have an elasticity calculated to achieve the same effect as the tool balancers.

Electric working parts 16 of the sign and lamps 17 are carried on the cassette 12.

When lowered, simultaneous access is given to the inside surfaces of both panels 13, both diffuser panels 30, the electric working parts 16 of the sign, and the lamps 17.

The sign 10 comprises a locking mechanism (not shown) that can be used to ensure that when in the dropped down position the base of the cassette 12 is 0.5 metres above pavement height.

Thus posting, and servicing of the lighting and electrics is achievable at ground level, without the need for ladders, scaffolding, scissor lifts, and/or dismantling the sign 10.

The sign 10 comprises a superstructure frame 20 that is fixed to the post 11 and carries the outer glazing Polycarbonate panels 13. The frame is made of identical top and bottom support arms 18 that are made of metal, such as aluminium or sheet steel, welded to form an integral part of the frame 20. Extruded aesthetic aluminium side claddings 21 are attached to complete four sides of the frame 20. A top plate 22 in sheet aluminium is cut to the aesthetic curve of the sign 10.

As well as the extrusions in the cassette 12, the sliding mechanism 14 comprises two rectangular aluminium extrusions which are bolted to the central post 11. The two constant tension tool balancers 15 are fixed to the superstructure 20 and have cables 23 running to the drop-down cassette 12.

The Polycarbonate panels 13 are retained on the superstructure by an aesthetic aluminium extrusion on four sides of each panel. Vertical extrusions 24 are straight and fixed to the side cladding 21. Horizontal extrusions 25 are rolled to the aesthetic curve of the sign 10.

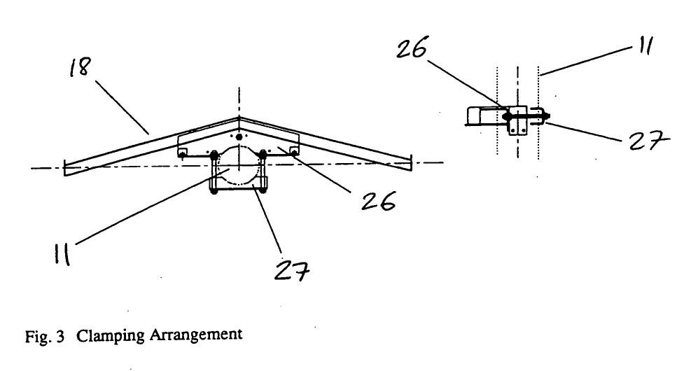

The sign 12 can be clamped to the post 11 by the top and bottom support arms 18. On each arm 18 is a two piece fabricated steel clamp, shown in FIG. 3, that is cut to the profile of the post and bolted together. One piece 26 is welded to the top and bottom support arms 18. Another part 27 of the clamp 28 is floating.

The electrical working parts and lamp can comprise two 70 W T8 lamps 17 and a 270 HF ballast 16.

Access to the cassette 12 can be achieved as follows:
Insert two keys into two compression locks 19 provided on the base plate 34 from underneath.
Unlock compression locks (the keys will be retained in the locks).
Gently pull on keys—the cassette 12 will slide down with minimal effort to extent of sliding mechanism.

When the cassette is in its lowered position, the following apply:
The lighting automatically switches off (a plug-socket arrangement, 32 is provided to ensure this).
Both diffuser 30 faces may be posted and/or cleaned.
Lamps 17 may be accessed.
The ballast 16 may be accessed.

Lighting and Electrics

Illumination can be provided by two 70 W 6500K T8 fluorescent lamps 17, fired by a single 270 HF controller 16. Several factors aid the distribution of light, creating a uniform illumination of the displayed image:

Full box length lamps.

All internal faces painted matt white.

The convex shape of the box of the sign 10 allowing light rays more space to reflect and interact.

Highly reflective but diffuse sheets 30 in proximity to the lamps.

Shaping the sliding mechanism extrusion near the lamp so as to be triangular and painting it white.

Firing lamps on high frequency (HF) gear gives considerable energy savings over conventional switch start/choke and starter systems.

In the foregoing description, for purposes of explanation, numerous specific details have been set forth in order to provide a thorough understanding of the present invention. It is important to understand that the present invention may be practiced with some or all of these specific details. Those skilled in the art will recognize modifications and alterations upon a reading and understanding of this specification. The present invention is intended to include all such modifications and alterations insofar as they come within the scope of the appended claims or the equivalents thereof.

1. A display apparatus for the display of advertising or other information comprising a rigid frame structure adapted to be clamped to a post in an elevated position, characterised by a drop down cassette the faces of which are designed to accept translucent advertising or public information posters and containing within the cassette electrical working parts of the apparatus and one or more lamps to illuminate the posters.

2. Apparatus according to claim 1 in which the base of the cassette has access for one or more keys which when inserted and turned unlock the cassette thereby to release the cassette from the apparatus and allow it to be lowered.

3. Apparatus according to claim 1 wherein the weight of the cassette is counterbalanced by a counterbalance means.

4. Apparatus according to claim 3 wherein the counterbalance means comprises a constant tension balancer or at least one shock cord.

5. Apparatus according to claim 4 wherein the balancer is adjustable to counterbalance a predetermined nominal weight of the cassette.

6. Apparatus according to claim 1 wherein the cassette is securely maintained in alignment with the post by substantially vertical metal extrusions bolted to the pole that constitute slide means, and the cassette slides in said slide means on descent and ascent of the cassette

7. Apparatus according to claim 6 wherein the extrusions are triangularly profiled to reduce occlusion of the light emitted by the one or more lamps.

8. Apparatus according to claim 2 wherein locks are provided at a base of the cassette.

9. Apparatus according to claim 8 wherein the locks are compression locks which will not release the lock until a compression force is applied to the locks after a predetermined rotation of a key thus preventing any inadvertent drop of the cassette.

10. Apparatus according to claim 1 wherein a locking mechanism retains the base of the cassette 0.5 metres above the pavement, thus presenting the poster face in the correct ergonomic position for the change of posters and adding further to the safety provided by the constant tension tool balancers, during this operation.

11. Apparatus according to claim 1 in which the side profiles of the cassette allow both lamps and electrical gear to be changed with no strip down of the unit.

12. Apparatus according to claim 1 in which the faces of the cassette can be accessed for cleaning without strip down of the unit.

13. Apparatus according to claim 1 in which the structure glazing is of curved polycarbonate that is highly resistant to vandal damage from thrown objects.

14. A lighting apparatus according to claim 1 in which the interior face of the diffusive glazing in the cassette is laminated with a highly reflective film that reflects and refracts the light output from the lamps to give a non-striping, bright image to the posters.

15. Apparatus according to claim 6 wherein a locking mechanism retains the base of the cassette 0.5 metres above the pavement, thus presenting the poster face in the correct ergonomic position for the change of posters and adding further to the safety provided by the constant tension tool balancers, during this operation.

16. Apparatus according to claim 6 wherein the side profiles of the cassette allow both lamps and electrical gear to be changed with no strip down of the unit.

17. Apparatus according to claim 6 wherein the faces of the cassette can be accessed for cleaning without strip down of the unit.

18. Apparatus according to claim 6 wherein the structure glazing is of curved polycarbonate that is highly resistant to vandal damage from thrown objects.

19. Apparatus according to claim 6 wherein the interior face of the diffusive glazing in the cassette is limited with a highly reflective film that reflects and refracts the light output from the lamps to give a non-striping, bright image to the posters.

20. Apparatus according to claim 2 wherein the cassette is securely maintained in alignment with the post by substantially vertical metal extrusions bolted to the pole that constitute slide means, and the cassette slides in said slide means on descent and ascent of the cassette.
